(19) United States
(12) Patent Application Publication
(10) Pub. No.: US 2026/0288375 A1
(43) Pub. Date: Sep. 24, 2026

(54) ADAPTIVE OPERATING MODE SELECTION FOR A DATA STORAGE DEVICE

(71) Applicant: Sandisk Technologies, Inc., Milpitas, CA (US)

(72) Inventors: Ojasweeta Singh, Bangalore (IN); Ramanathan Muthiah, Bangalore (IN); Ramkumar Ramamurthy, Bangalore (IN)

(21) Appl. No.: 19/082,471

(22) Filed: Mar. 18, 2025

(51) Int. Cl. G06F 3/06

(52) U.S. Cl. CPC G06F 3/0659; G06F 3/0604; G06F 3/0679

(57) ABSTRACT

A data storage device includes a mode selection system that determines whether the data storage device is operating in a first mode, in which a first type of data is received, or in a second mode, in which a second type of data is received. When operating in the first mode and/or when the first type of data is received, the mode selection system determines one or more L2P pages that are associated with the data and loads the L2P pages into a cache of the data storage device. As data is written to the persistent storage of the data storage device, L2P entries are generated. The L2P entries are applied directly to the one or more L2P pages in the cache, thereby bypassing a L2P queue in which L2P entries are typically stored. When the L2P page is full, the L2P page is flushed to persistent storage.

### BACKGROUND

When a data storage device receives a write command and associated data from a host device, the data is written to persistent storage (e.g., one or more NAND memory dies) of the data storage device. As part of this process, a controller of the data storage device also updates a mapping between a logical block address (LBA) associated with the data and the physical address associated with the data.

For example, when the data is written to the persistent storage, logical to physical (L2P) entries associated with the data are generated and stored in a queue. When a particular number of L2P entries have been stored in the queue (or when then queue is full), the L2P entries are flushed from the queue and stored in corresponding L2P pages in a L2P mapping table. This approach avoids frequent loading and flushing of L2P pages to/from persistent storage and reduces overhead when the data storage device receives different types of data.

However, there are some situations in which a data storage device is required to provide and maintain certain performance metrics. For example, when the data storage device is storing audiovisual data or sequential data, the data storage device may be required to provide or support certain performance metrics over a particular period of time. However, flushing the L2P entries from the queue to the persistent storage will ultimately cause a bottleneck, which decreases the overall performance of the data storage device and will ultimately prevent the data storage device from meeting the required performance metrics.

Accordingly, it would be beneficial for a data storage device to have a dynamic approach for updating an L2P mapping table with various L2P entries when data is received from a host device.

### SUMMARY

The present disclosure describes a mode selection system for a data storage device. In an example, the mode selection system is operable to determine whether the data storage device should operate in a first mode in which a first type of data is received from a host device or in a second mode in which a second type of data is received from the host device.

When the data storage device is operating in the first mode and/or when the first type of data is received, the mode selection system determines or identifies one or more logical to physical (L2P) pages that are associated with the data and loads the one or more L2P pages into a cache of the data storage device. As the data is written to the persistent storage of the data storage device and as L2P entries are generated, the L2P entries are provided, applied or written directly to the one or more L2P pages in the cache, thereby bypassing a L2P queue (e.g., a uLayer) in which the L2P entries are typically stored. When a particular L2P page is fullor all entries have been applied, the L2P page is flushed to persistent storage.

When the data storage device is operating in second mode and/or when the second type of data is received, the mode selection system causes the data to be written to persistent storage and any L2P entries that are generated are stored in the L2P queue. When the L2P queue is full, or when a threshold number of L2P entries have been added to the L2P queue, the L2P queue is flushed to corresponding L2P pages of a L2P mapping table in persistent storage.

Accordingly, examples of the present disclosure describe a method that includes receiving a write command from a host device and determining whether data associated with the write command is a first type of data or a second type of data. Based, at least in part, on determining the data associated with the write command is the first type of data, determining whether a L2P page associated with the data has been pre-loaded into a cache of a data storage device. Based, at least in part, on determining the L2P page associated with the data has been pre-loaded into the cache, the L2P page associated with the data is updated. The L2P page is also moved from the cache of the data storage device to persistent storage of the data storage device.

Examples also describe a data storage device having a controller and a mode detection system. In an example, the mode detection system is operable to receive a first command from the host device and allocate a sequential storage area in the data storage device based, at least in part, on receiving the first command. The mode detection system is also operable to determine a starting logical block address (LBA) associated with the sequential storage area and pre-load one or more logical to physical (L2P) pages associated with the starting LBA to a cache of the data storage device. In response to receiving a second command from the host device, the mode detection system stores data associated with the second command in persistent storage of the data storage device and updates the one or more pre-loaded L2P pages in the cache. In an example, the one or more pre-loaded L2P pages in the cache are updated based, at least in part, on storing the data associated with the second command in the persistent memory of the data storage device.

Still other examples describe a data storage device having a means for receiving a write command from a host device and a means for determining a type of data associated with the write command. The data storage device also includes a means for determining whether a logical to physical (L2P) page associated with the data has been pre-loaded into a cache of the data storage device when the means for determining the type of data associated with the write command determines that the data associated with the write command is a particular type of data. The data storage device also includes a means for updating the L2P page in the cache associated with the data while bypassing a L2P queue and a means for moving the L2P page from the cache of the data storage device to persistent storage of the data storage device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of a system that includes a host device and a data storage device according to an example.

FIG. 2 illustrates various commands that are issued by a host device and received by a data storage device to enable a mode selection system of the data storage device to determine whether to operate in a first mode or a second mode according to an example.

FIG. 3 illustrates a cache of a data storage device that includes various L2P pages according to an example.

FIG. 4 illustrates a L2P queue of a data storage device that includes various L2P entries according to an example.

FIG. 5 illustrates a method for determining an operating mode of a data storage device according to an example.

FIG. 6 illustrates a method for loading L2P pages in a cache of a data storage device according to an example.

FIG. 7 illustrates a method for updating one or more L2P pages in a cache of a data storage device according to an example.

FIG. 8 illustrates a method for updating a L2P queue with L2P entries according to an example.

FIG. 9 is a perspective view of a storage device that includes three-dimensional (3D) stacked non-volatile memory according to an example.

FIG. 10 is a block diagram of a storage device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

In order to store real-time audiovisual data or other sequential data, a data storage device may be required to meet certain performance metrics. However, as previously described, conventional methods of updating a logical to physical (L2P) mapping table may cause the data storage device to fall below the required performance metrics.

For example, in current implementations, when data is written to persistent storage of the data storage device, L2P entries associated with the data are generated and stored in a L2P queue (also referred to as a uLayer or a delta). When a particular number of L2P entries have been stored in the L2P queue (or when the L2P queue is full), the L2P entries are flushed from the L2P queue and stored in corresponding L2P pages in a L2P mapping table. However, flushing the L2P entries from the L2P queue increases the workload of the controller of the data storage device, which may eventually prohibit the data storage device from meeting the required performance metrics.

To address the above, the present disclosure describes a mode selection system for a data storage device. The mode selection system determines whether the data storage device should operate in a first mode, in which a first type of data is received from a host device, or in a second mode, in which a second type of data is received from the host device. In an example, the first type of data is audiovisual data or real-time audio visual data and the mode selection system determines that the data storage device should operate in the first mode based, at least in part, on a command received from the host device.

When the data storage device is operating in the first mode, and/or when the first type of data is received, the mode selection system determines or identifies one or more L2P pages that are associated with the data. The mode selection system then loads the one or more L2P pages into a cache of the data storage device. As the data is written to the persistent storage of the data storage device, L2P entries are generated. Once generated, the L2P entries are stored directly in the one or more L2P pages in the cache, thereby bypassing the L2P queue in which the L2P entries are typically stored. When a particular L2P page is full, the L2P page is (immediately) flushed to persistent storage.

The mode selection system is also able to determine whether the data storage device should operate (or is operating) in the second mode. When the data storage device is operating in the second mode, and/or when the second type of data is received, the mode selection system causes the data to be written to persistent storage of the data storage device. Any L2P entries that are generated as part of this process are stored in the L2P queue. When the L2P queue is full, or when a threshold number of L2P entries have been added to the L2P queue, the L2P queue is flushed to corresponding L2P pages of a L2P mapping table in the persistent storage of the data storage device.

Accordingly, many technical benefits may be realized including, but not limited to, increasing performance metrics of sequential read and/or write operations of the data storage device, reducing a utilization of a random access memory of the data storage device which, in turn, can be used to optimize other operations to further improve the performance metrics of the data storage device and reducing write amplification of the data storage device.

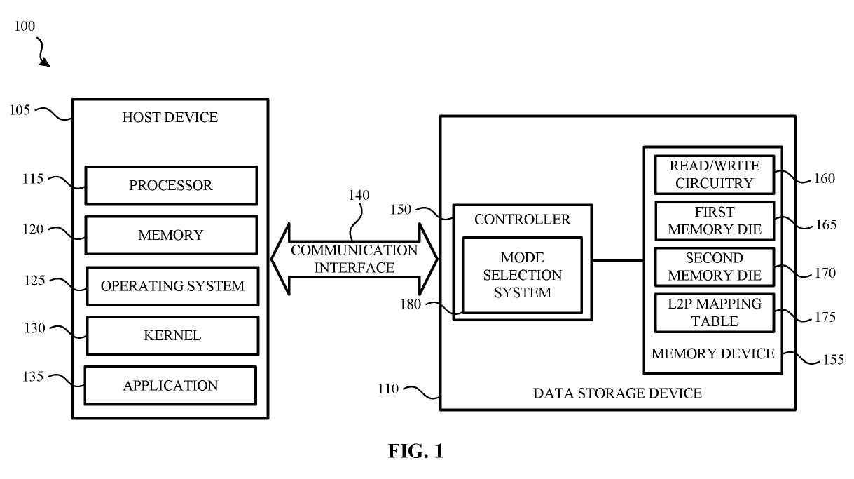

These benefits, along with other examples, will be shown and described in greater detail with respect to FIG. 1 – FIG. 10.

FIG. 1 is a block diagram of a system 100 that includes a host device 105 and a data storage device 110 according to an example. In an example, the host device 105 includes at least one processor 115 and a memory 120 (e.g., main memory). The memory 120 includes or is otherwise associated with an operating system 125, a kernel 130 and/or an application 135.

The processor 115 can execute various instructions, such as, for example, instructions from the operating system 125 and/or the application 135. The processor 115 may include circuitry such as a microcontroller, a Digital Signal Processor (DSP), an Application-Specific Integrated Circuit (ASIC), a Field Programmable Gate Array (FPGA), hard-wired logic, analog circuitry and/or various combinations thereof. In an example, the processor 115 may include a System on a Chip (SoC).

In an example, the memory 120 can be used by the host device 105 to store data used, or otherwise executed by, the processor 115. Data stored in the memory 120 may include instructions provided by the data storage device 110 via a communication interface 140. The data stored in the memory 120 may also include data used to execute instructions from the operating system 125 and/or one or more applications 135. The memory 120 may be a single memory or may include multiple memories, such as, for example one or more non-volatile memories, one or more volatile memories, or a combination thereof.

In an example, the operating system 125 creates a virtual address space for the application 135 and/or other processes executed by the processor 115. The virtual address space maps to locations in the memory 120. The operating system 125 also includes or is otherwise associated with a kernel 130. The kernel 130 includes instructions for managing various resources of the host device 105 (e.g., memory allocation), handling read and write requests and so on.

The communication interface 140 communicatively couples the host device 105 and the data storage device 110. The communication interface 140 may be a Serial Advanced Technology Attachment (SATA), a PCI express (PCIe) bus, a Small Computer System Interface (SCSI), a Serial Attached SCSI (SAS), Ethernet, Fibre Channel, or Wi-Fi. As such, the host device 105 and the data storage device 110 need not be physically co-located and may communicate over a network such as a Local Area Network (LAN) or a Wide Area Network (WAN), such as the internet. In addition, the host device 105 may interface with the data storage device 110 using a logical interface specification such as Universal Serial Bus (USB), Non-Volatile Memory express (NVMe) or Advanced Host Controller Interface (AHCI).

The data storage device 110 includes at least one controller 150, processor and/or processing unit and at least one memory device 155. The controller 150 is communicatively coupled to the memory device 155. In an example, the data storage device 110 may include multiple controllers, processors or processing units. In such an example, one controller is responsible for executing a first operation or set of operations and a second controller is responsible for executing a second operation or set of operations.

In an example, the memory device 155 includes one or more memory dies (e.g., first memory die 165 and second memory die 170). Although two memory dies are shown, the memory device 155 may include any number of memory dies (e.g., one memory die, two memory dies, eight memory dies, or another number of memory dies). Additionally, although memory dies are specifically mentioned, the memory device 155 may include any non-volatile memory device, storage device, storage elements or storage medium including NAND flash memory cells and/or NOR flash memory cells.

The memory cells can be one-time programmable, few-time programmable, or many-time programmable. Additionally, the memory cells may be single-level cells (SLCs), multi-level cells (MLCs), triple-level cells (TLCs), quad-level cells (QLCs), penta-level cells (PLCs), and/or use any other memory technologies. The memory cells may be arranged in a two-dimensional configuration or a three-dimensional configuration.

In an example, one or more of the first memory die 165 and the second memory die 170 include one or more planes and each of the one or more planes includes one or more memory blocks. In an example, each memory block includes one or more pages made up of one or more memory cells. A block of memory cells is the smallest number of memory cells that are physically erasable together. In an example and for increased parallelism, each of the memory blocks may be operated or organized in larger blocks or metablocks. For example, one block from different planes may be logically linked together to form a metablock.

In some examples, the data storage device 110 may be attached to, or embedded within, the host device 105. In another example, the data storage device 110 may be implemented as an external device, a memory card, and/or a portable device that can be communicatively or selectively coupled to the host device 105. In yet another example, the data storage device 110 may be a component (e.g., a solid-state drive (SSD)) of a network accessible data storage system, a network-attached storage system, a cloud data storage system, and the like.

In an example, the data storage device 110 supports the Video Speed Class (VSC) specification. As such, the data storage device 110 stores real-time audiovisual data, real-time sequential data and/or real-time recordings. Because the data storage device 110 supports the VSC specification, the data storage device 110 may be required to meet certain performance requirements or metrics. For example, the data storage device 110 may be required to provide sustained performance “C MB/s” for a range of 600MB. Although specific performance metrics are mentioned, this is for example purposes only.

The memory device 155 also includes support circuitry. In an example, the support circuitry includes read/write circuitry 160. The read/write circuitry 160 supports the operation of the memory dies of the memory device 155. Although the read/write circuitry 160 is depicted as a single component, the read/write circuitry 160 may be divided into separate components, such as, for example, read circuitry and write circuitry. The read/write circuitry 160 may be external to the memory dies of the memory device 155. In another example, one or more of the memory dies may include corresponding read/write circuitry 160 that is operable to read data from and/or write data to storage elements within one individual memory die independent of other read and/or write operations on any of the other memory dies.

The memory device 155 also stores a L2P mapping table 175. In an example, the L2P mapping table 175 is part of a flash transition layer (FTL) of the data storage device 110. The L2P mapping table 175 stores a mapping between Logical Block Addresses (LBAs) used by the host device 105 and the physical block addresses (PBAs) where data is physically stored in the various memory dies of the memory device 155.

As previously described, the data storage device 110 includes at least one controller 150. Although a controller 150 is specifically mentioned, the controller 150 may be a processor, multiple processors, a processing unit, processing circuitry and the like. The controller 150 is communicatively coupled to the memory device 155 via a bus, an interface or other communication circuitry.

In an example, the communication circuitry may include one or more channels to enable the controller 150 to communicate with the first memory die 165 and/or the second memory die 170 of the memory device 155. In another example, the communication circuitry may include multiple distinct channels which enables the controller 150 to communicate with the first memory die 165 independently and/or in parallel with the second memory die 170 of the memory device 155.

The controller 150 may receive data and/or instructions from the host device 105. The controller 150 may also send data to the host device 105. For example, the controller 150 may send data to and/or receive data from the host device 105 via the communication interface 140. The controller 150 may also send data and/or commands to and/or receive data from the memory device 155.

The controller 150 may send data and a corresponding write command to the memory device 155 to cause the memory device 155 to store data at a specified address of the memory device 155. In an example, the write command specifies a physical address of a portion of the memory device 155. The controller 150 may also send data and/or commands associated with one or more background scanning operations, garbage collection operations, and/or wear leveling operations. The controller 150 may also send one or more read commands to the memory device 155. In an example, the read command specifies the physical address of a portion of the memory device 155 at which the data is stored.

The controller 150 may also include or otherwise be associated with a mode selection system 180. The mode selection system 180 may be a packaged functional hardware unit designed for use with other components/systems, a portion of a program code (e.g., software or firmware) executable by the controller 150, a processor and/or processing circuitry, or a self-contained hardware and/or software component that interfaces with other components and/or systems.

In an example, the mode selection system 180 is operable to determine whether the data storage device 110 is operating, or should be operating, in a first mode or a second mode. In an example, the first mode is a mode in which the data storage device 110 receives and stores a first type of data. In an example, the first type of data is sequential data. In another example, the first type of data is real-time audiovisual data and/or data that is associated with, or specified by the VSC specification.

As a result, when the first type of data is received from the host device 105 and written to the memory device 155, the mode selection system 180 determines a LBA range associated with the first type of data and pre-loads one or more L2P pages associated with the LBA range to a cache of the data storage device 110. The mode selection system 180 also updates L2P entries in the L2P pages in the cache. The mode selection system 180 also determines whether and when to flush the L2P pages in the cache to persistent storage (e.g., the L2P mapping table 175 of the memory device 155) of the data storage device 110.

In an example, the second mode is a mode in which a second type of data is received by the data storage device 110. In an example, the second type of data is non-sequential data or data that is identified as non-VSC data. In examples in which the second type of data is received from the host device 105, the mode selection system 180 causes the second type of data to be stored in the memory device 155. The mode selection system 180 also generates and/or stores L2P entries associated with the second type of data in a L2P queue (e.g., a uLayer or a delta). When the L2P queue is full, or when a threshold number of L2P entries are in the L2P queue, the mode selection system 180 applies the L2P entries to the L2P pages and flushes the L2P pages to persistent memory (e.g., flash memory) of the data storage device 110. For example, the L2P pages are flushed to the L2P mapping table 175.

In an example, and as will be described in greater detail herein, the mode selection system 180 will allocate a sequential data area in the memory device 155 and also allocate a random data area in the memory device 155. In an example, the sequential data area and the random data area are allocated in response to one or more commands received from the host device 105. In an example, the one or more commands are Dataset Management Commands associated with the VSC command specification. When the sequential data area and the random data area of the data storage device 110 have been allocated, the mode selection system 180 determines, based at least in part, on the type of data received and/or on one or more commands that are received, whether to store the data in the sequential data area or the random data area and whether to pre-load and update one or more L2P pages in a cache or whether to store L2P entries in an L2P queue.

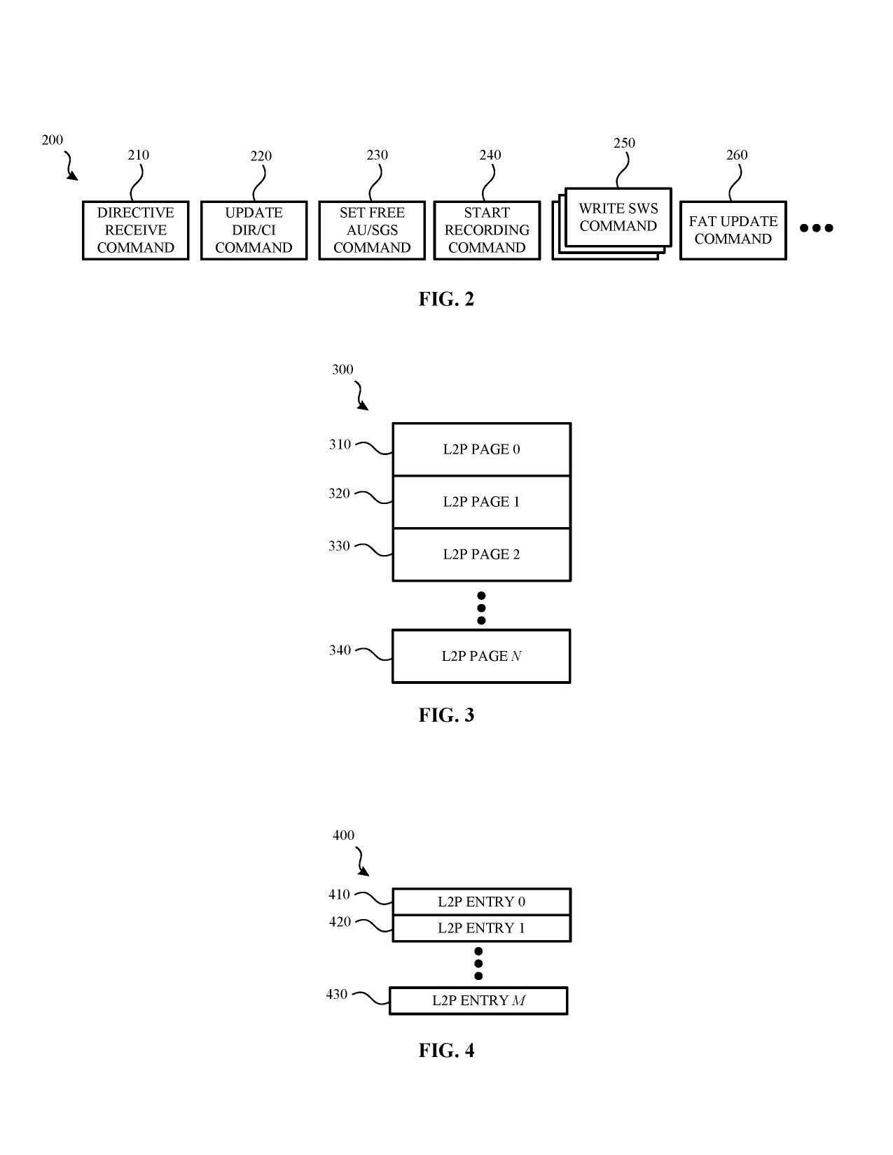

FIG. 2 illustrates various commands 200 that are issued by a host device and received by a data storage device to enable a mode selection system of the data storage device to determine whether to operate in a first mode or a second mode according to an example. In an example, the host device that issues the commands 200 is similar to the host device 105 shown and described with respect to FIG. 1. Likewise, the data storage device and/or the mode selection system are similar to the data storage device 110 and the mode selection system 180 shown and described with respect to FIG. 1. In an example, the commands 200 are Dataset Management Commands (DSM) commands and/or are associated with the VSC command specification. Each of the various commands will be explained in greater detail herein. However, although DSM commands are specifically mentioned, other commands may be used.

Additionally, in the examples that follow, the data storage device may operate in a non-VSC state (e.g., a state where speed class recording is unavailable because the resources for speed class recording have not yet been allocated) by default. When the data storage device is operating in the non-VSC mode, the data storage device is referred to as operating in the second mode. When the data storage device is operating in the VSC mode, the data storage device is referred to as operating in the first mode.

In an example, the first command that is received by the mode selection system is a directive receive command 210. The directive receive command 210 is a command that notifies the mode selection system that the data storage device is to operate in the first mode (e.g., the VSC mode).

The host device may also provide a second command to the mode selection system. In an example, the second command is a update DIR/CI command 220. In response to receiving the update DIR/CI command, the mode selection system allocates random areas in the data storage device. The random areas may be used to record and/or store a directory entry (DIR) or continuous information (CI). In an example, a number of random areas that are allocated by this command is specified by a number of ranges (NR) in a command parameter. In an example, the update DIR/CI command specifies that a starting LBA is aligned to 16 kilobytes (KB) in a “User Area”, and the length in logical blocks is 16KB, although this is for examples purposes only.

In an example, the User Area (UA) is divided into a non-stream recordable area and a stream recordable area. A non-stream recordable area is set to store file system information and is not used for stream recording. A stream-recordable area starts from a Stream Granularity Size (SGS) boundary (e.g., an optimal size for managing a stream and it corresponds to the an allocation unit (AU) in the Speed Class) after the end of the non-stream recordable area and terminates at the end of the User Area.

The mode selection system may also receive a third command from the host device. In an example, the third command is a set free AU/SGS command 230. In an example, the set free AU/SGS command 230 causes the mode selection system to allocate SGS units in the data storage device to record stream data. An NR field in the set free AU/SGS command 230 indicates a number of ranges to be assigned as a sequential area in the data storage device. In an example, a starting LBA is aligned to the SGS boundary and a length of a logical block is a multiple of the SGS. In an example, the set free AU/SGS command 230 causes the mode selection system to be aware of the ranges that are marked as sequential areas by the host device.

As a result, and when the host device issues a fourth command (e.g., a start recording command 240), the mode selection system pre-loads L2P pages associated with the starting LBA (e.g., the LBA that was determined or identified as part of the AU/SGS command 230) in a cache. When the write operation is finished for a range of one L2P page, the mode selection system flushes the L2P page to persistent storage.

For example, when the data storage device is in a speed class recording mode, a VSC mode, or the first mode, and a sequential data area in the data storage device has been allocated (e.g., based on the mode selection system receiving one or more commands), the host device provides a start recording command 240 to the mode selection system. When the start recording command 240 is received, the mode selection system determines a start LBA of the SGS from where the data will be stored. Because L2P pages are mapped with the LBA, the mode selection system will be able to identify L2P pages that will be used to perform, or are otherwise associated with, a write command issued by the host device.

As a result, the mode selection system will pre-load the L2P pages associated with the LBA in the cache. In an example, the mode selection system pre-loads the L2P pages at timestamps where a workload of the controller (or firmware associated with the controller) is less when compared with other timestamps. For example, the mode selection system will pre-load the L2P pages in the cache when a start recording command 240 is issued by the host device and/or when a FAT update command 260 is issued by the host device.

For example, when a start recording command 240 is received by the mode selection system, the mode selection system loads one or more L2P pages in the cache and causes them to be available for updates. In an example, the mode selection system determines whether a workload of the controller is below a workload threshold and loads L2P pages when the workload is below the workload threshold. In an example, the start recording command 240 is associated with a timeout. As such, a workload of the controller may be less during the timeout when compared with other time periods.

The host device may also issue one or more write stream write size (SWS) commands 250. In an example, SWS command indicates an optimal unit for stream data recording. In an example, the SWS size can be either 4 megabytes (MB), 5MB or 6MB, although other sizes may be used.

In an example, after one or more write SWS commands 250 are received, the host device may issue a FAT update command 260. In an example, the FAT update command 260 takes less time to complete when compared with the write SWS command 250 because a FAT update writes a small amount of data (e.g., 4KB). As such, and as previously explained, when a FAT update command 260 is received, the mode selection system may load additional L2P pages in the cache. In an example, the host device may issue any number of write SWS commands 250 followed by a FAT update command 260.

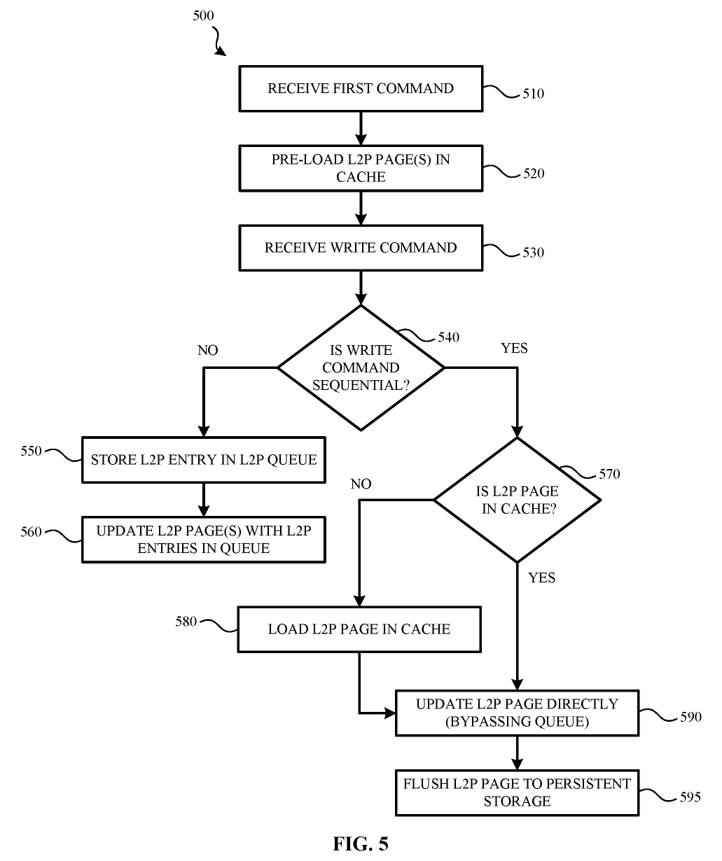

FIG. 3 illustrates a cache 300 of a data storage device that includes various L2P pages according to an example. In an example, the cache 300 is part of the data storage device 110 shown and described with respect to FIG. 1. Additionally, in an example, the L2P pages that are stored in the cache 300 are pre-loaded in the cache by a mode selection system, such as, for example, the mode selection system 180 shown and described with respect to FIG. 1.

For example and as previously described, when a particular command is received from a host device (e.g., a start recording command), the particular command may provide a starting LBA for the data. Using this information, the mode selection system identifies one or more L2P pages that are mapped to, or are otherwise associated with, the LBA. For example, when the particular command is received, the mode selection system determines that L2P page 0 310, L2P page 1320, L2P page 2330 and L2P page N 340 are associated with the LBA range. As such, the mode selection system will pre-load one or more of the L2P pages in the cache 300.

However, in some examples, due to time constraints and/or a current workload, the mode selection system may not be able to load each L2P page in the cache 300 at the same time. For example, when the particular command is issued by the host device, the mode selection system may be able to only pre-load L2P page 0 310 and L2P page 1320 into the cache 300. As a result, when another command is received (e.g., a FAT update command), the mode selection system may be able to pre-load L2P page 2 330 and/or L2P page N 340 into the cache 300.

In an example, pre-loading the L2P pages in the cache 300 reduces the usage of RAM of the data storage device that otherwise would have been used by data storage device to keep the L2P pages in a L2P queue. Because RAM usage is freed, the data storage device can use the “freed” RAM for other operations. In an example, the operations describe above also reduce an amount of CPU cycles needed to update and/or maintain the queue of L2P entries in persistent storage when compared with current solutions.

FIG. 4 illustrates a L2P queue 400 of a data storage device that includes various L2P entries according to an example. In an example, the L2P queue 400 is part of the data storage device 110 shown and described with respect to FIG. 1. Additionally, in an example, the L2P entries that are stored in the L2P queue 400 are stored in the L2P queue 400 by a mode selection system, such as, for example, the mode selection system 180 shown and described with respect to FIG. 1. In an example, the L2P entries are stored or otherwise provided in the L2P queue 400 when the data storage device is operating in a non-VSC mode or a second mode and/or when a second type of data is received by the data storage device.

For example, when the mode selection system receives a write command from a host device, the mode selection system may determine that the write command is not a sequential write command, that the data associated with write command is the second type of data and/or that the data storage device is operating in the second mode. As such, when the write command is received, the mode selection system causes data associated with the write command to be written to persistent storage. The mode selection system then causes one or more L2P entries associated with the data to be stored in the L2P queue 400.

For example, in response to receiving one or more write commands from the host device, the mode selection system generates one or more of L2P entry 0410, L2P entry 1420 and L2P entry M 430. These L2P entries are then stored in the L2P queue 400. When the mode selection system determines that a threshold number of L2P entries are in the L2P queue 400 (or when the mode selection system determines that the L2P queue 400 is full), the mode selection system flushes the L2P entries in the L2P queue 400 to persistent storage.

FIG. 5 illustrates a method 500 for determining an operating mode of a data storage device according to an example. In an example, the method 500 is performed by a controller and/or a mode selection system of a data storage device such as, for example, the controller 150 and/or the mode selection system 180 of the data storage device 110 shown and described with respect to FIG. 1.

In an example, the data storage device is operating in first mode, or a VSC mode such as previously described and the mode selection system receives (510) a first command. In an example, the first command is a write SWS command such as previously described. For example, the write SWS command is a specific VSC command where the host device hints at a VSC operation and the ranges involved in the upcoming operations. In response to receiving the first command, the mode selection system pre-loads (520) one or more L2P pages in a cache.

The mode selection system may also receive a write command (530) (e.g., an I/O write command) from the host device. The write command follows the SWS command and specifies the LBA start and size of the data which may fall within the range specified by the write SWS command. In an example, the write command is also associated with data. In response to receiving the write command, the mode selection system determines (540) whether the write command is a sequential command (e.g., a VSC command). If the mode selection system determines (540) that the write command is not a sequential command, the mode selection system generates one or more L2P entries and stores (550) the L2P entries in a L2P queue. In an example, the one or more L2P entries are generated as data associated with the write command is stored in persistent storage of the data storage device.

This process may be repeated any number of times until the mode selection system determines that the L2P queue is full and/or until the mode selection system determines a threshold number of L2P entries have been added to the L2P queue. When one or both of these criteria have been met, the mode selection system updates (560) one or more L2P pages of a L2P mapping table with the L2P entries in the L2P queue.

However, if the mode selection system determines (540) that the write command is a sequential command, the mode selection system determines (570) whether a L2P page associated with the write command is in a cache of the data storage device. If the mode selection system determines (570) the L2P page associated with the write command is in the cache, the L2P page associated with the data is directly updated (590) and the L2P queue is bypassed. When a range associated with the L2P page has been met, the L2P page is flushed (595) to persistent storage of the data storage device.

However, if the mode selection system determines (540) that the L2P page associated with the write command is not in the cache, the mode selection system loads (580) the L2P page to the cache. In an example, the L2P page is loaded to the cache when a workload of the controller and/or the mode selection system is below a workload threshold. In another example, the L2P page is loaded to the cache when a particular command is received from the host device. For example, the L2P page is loaded to the cache when a FAT update command is received from the host device and/or when a start recording command is received from the host device.

When the L2P page has been loaded into the cache, the mode selection system causes the L2P page associated with the data to be directly updated (590), thereby bypassing the L2P queue. When a range associated with the L2P page has been updated or modified, the L2P page is flushed (595) to persistent storage of the data storage device.

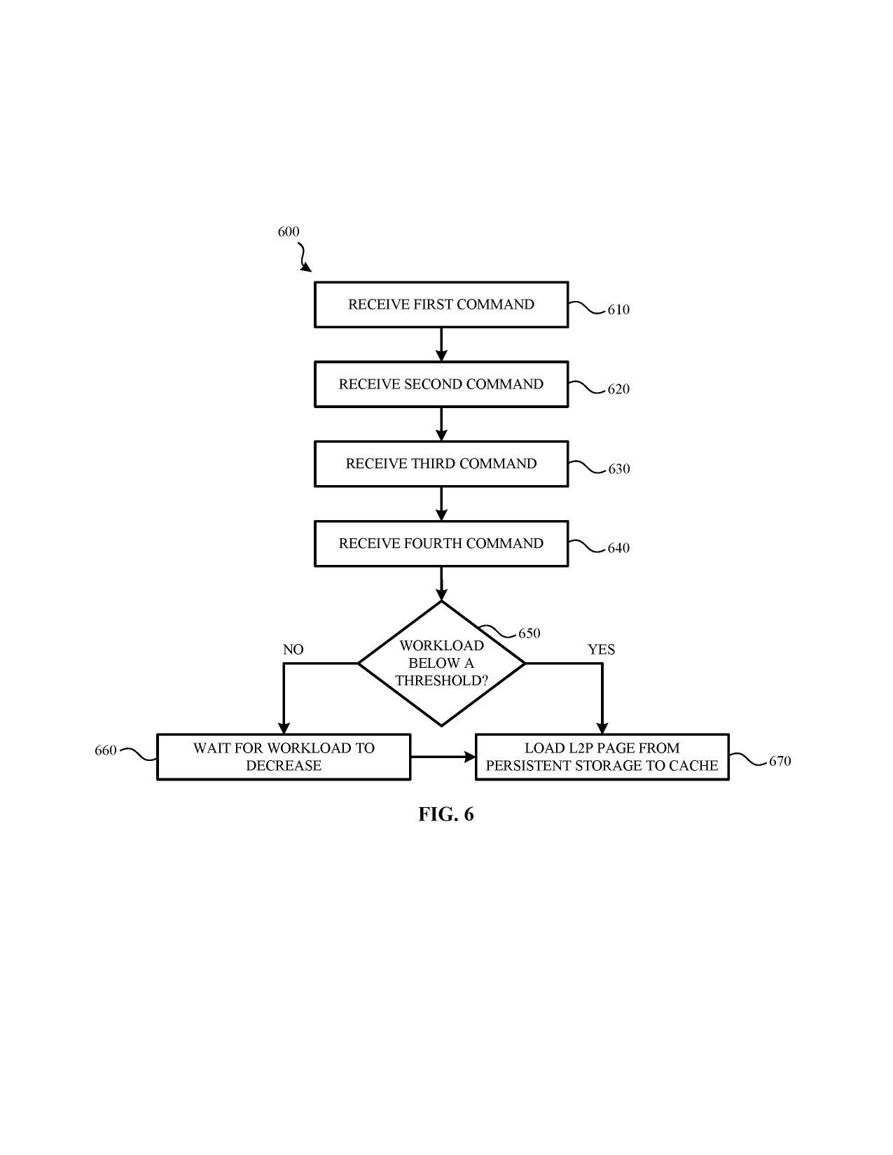

FIG. 6 illustrates a method 600 for loading L2P pages in a cache of a data storage device according to an example. In an example, the method 600 is performed by a controller and/or a mode selection system of a data storage device such as, for example, the controller 150 and/or the mode selection system 180 of the data storage device 110 shown and described with respect to FIG. 1.

In an example, when method 600 begins, the data storage device is operating in a second mode, or a non-VSC mode and the mode selection system receives (610) a first command. In an example, the first command is a directive receive command such as, for example, the directive receive command 210 shown and described with respect to FIG. 2. The mode selection system also receives (620) a second command and a third command (630). In an example, the second command is an update DIR/CI command and the third command is a set free AU/SGS command. For example, the second command is the update DIR/CI command 220 previously described with respect to FIG. 2 and the third command is the set free AU/SGS command 230 described with respect to FIG. 2.

When the mode selection system has executed the first command, the second command and the third command, a random storage area and a sequential storage area have been allocated in the data storage device based on the received commands, the mode selection system receives (640) a fourth command. In an example, the fourth command is a start recording command such as, for example, the start recording command 240 described with respect to FIG. 2. In an example, the fourth command includes a timeout (e.g., a one second timeout). As such, the mode selection system may be able to load one or more L2P pages into a cache during this timeout.

In response to receiving the fourth command, and during the timeout, the mode selection determines (650) whether a workload of the controller (and/or its own workload) is below workload threshold. If the mode selection system determines that the workload is above the workload threshold, the mode selection system waits (660) for the workload to decrease. When the workload of the controller has decreased, the mode selection system loads (670) one or more L2P pages from persistent storage of the data storage device to the cache.

However, if the mode selection system initially determines (650) that the workload of the controller is below the workload threshold, the mode selection system loads (670) one or more L2P pages from the persistent storage of the data storage device to the cache.

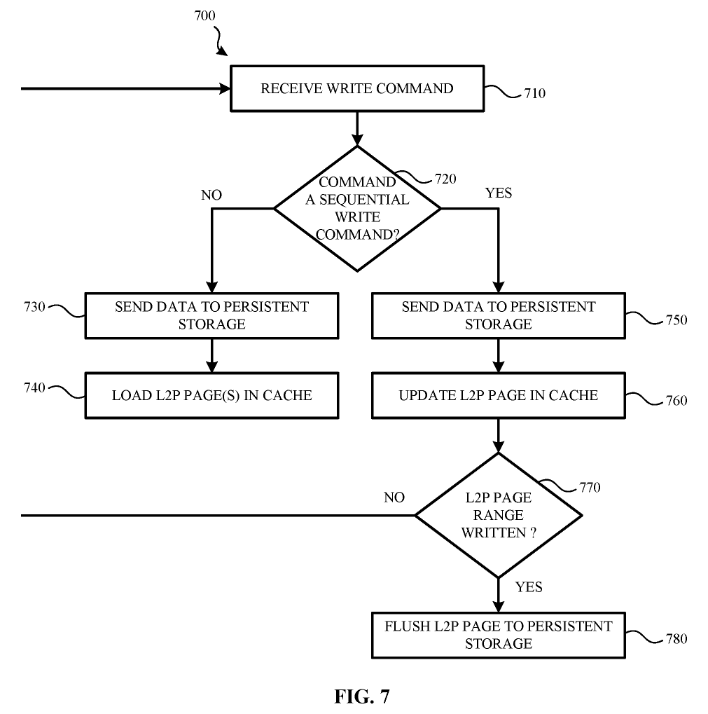

FIG. 7 illustrates a method 700 for updating one or more L2P pages in a cache of a data storage device according to an example. In an example, the method 700 is performed by a controller and/or a mode selection system of a data storage device such as, for example, the controller 150 and/or the mode selection system 180 of the data storage device 110 shown and described with respect to FIG. 1.

In an example, the method 700 begins when a write command is received (710) from a host device. In response to receiving the write command, the mode selection system determines (720) whether the write command is a sequential write command. If the mode selection system determines (720) the write command is not a sequential write command, the mode selection system determines the command is a FAT update command and/or sends data associated with the write command to persistent storage of the data storage device. In an example, the mode selection system may also generate one or more L2P entries associated with the data and store the L2P entries in a L2P queue such as previously described.

In an example, because the write command is not a sequential command, the workload of the controller and/or the mode selection system may be below a workload threshold. As such, the mode selection system loads (740) one or more L2P pages to the cache.

However, if the mode selection system determines (720) that the write command is a sequential write command, the mode selection system sends (750) data associated with the write command to persistent storage and updates (760) one or more L2P pages in the cache. The mode selection system also determines (770) whether a range associated with the L2P page has been written. If so, the L2P page is flushed (780) to persistent storage. In an example, the L2P page is flushed to persistent storage in response to a determination that the L2P range has been fully written. However, if the mode selection system determines (770) that the range associated with the L2P page has not been fully written, the method 700 is repeated.

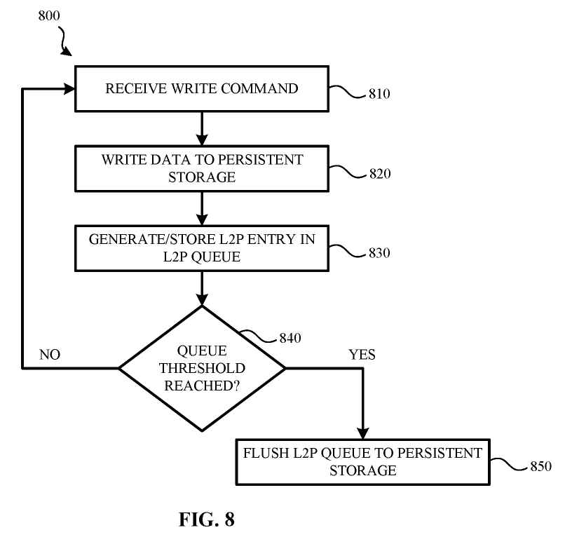

FIG. 8 illustrates a method 800 for updating a L2P queue with L2P entries according to an example. In an example, the method 800 is performed by a controller and/or a mode selection system of a data storage device such as, for example, the controller 150 and/or the mode selection system 180 of the data storage device 110 shown and described with respect to FIG. 1.

In an example, the method 800 begins when the mode selection system receives (810) a write command from a host device. In an example, the data storage device may be operating in a non-VSC mode or a second mode such as previously described. In another example, the write command that is received is not a sequential write command. As such, the mode selection system writes (820) the data associated with the received write command to persistent storage of the data storage device.

In addition, the mode selection system generates and/or stores (830) an L2P entry associated with the data in a L2P queue, such as, for example, the L2P queue 400 shown and described with respect to FIG. 4. The mode selection system may also determine (840) whether the L2P queue is full and/or whether a number of L2P entries in the L2P queue exceeds a L2P queue threshold.

If the mode selection system determines (840) that the L2P queue is full and/or exceeds the L2P queue threshold, the mode selection system flushes (850) the L2P entries in the L2P queue to persistent storage. For example, the mode selection system updates one or more L2P pages of a L2P mapping table that is stored in the data storage device.

However, if the mode selection system determines (840) that the L2P queue is not full and/or that the number of L2P entries in the L2P queue is below the L2P queue threshold, the method 800 is repeated.

In an example, each of the method 500 shown and described with respect to FIG. 5 may incorporate one or more of the method 600 shown and described with respect to FIG. 6, the method 700 shown and described with respect to FIG. 7, and/or the method 800 shown and described with respect to FIG. 8. Additionally, each of the various methods may be combined and/or performed at various times by the mode selection system.

In some examples, the various operations and methods described herein are applicable to use cases in which there is a long commitment of logical ranges associated with various write commands. For example, for some workloads, checkpointing (e.g., backing up results in a periodic manner in non-volatile memory) not only involves long sequential writes, but writing a predetermined long logical range. In such examples, mode selection system described herein can determine a checkpoint mode of operation and apply the various methods/operations described herein to create or generate a checkpoint stream and update the L2P pages directly for such streams and route the L2P entries of non-checkpoint stream through L2P queue updates.

In an example, the mode selection system can also handle a non-VSC stream by causing L2P entries to be stored into an L2P queue and while not caching the associated L2P page for a long period of time thereby optimizing resource usage (e.g., a cache) based on system requirements. For example, the mode selection system can create L2P entries and consolidate the L2P entries in the L2P queue when the L2P entries are less than a threshold for a control page.

In yet another example, the mode selection system evaluates a SGS range of speed class (that is to be written shortly), determines if any of the data in garbage collection source blocks clashes with the range, and accordingly postpones selection of the source block for garbage collection until the completion of that range, which reduces the overhead associated with garbage collection operation. In an example, delaying the garbage collection of such blocks enhances the quality of service (QoS) of the data storage device by minimizing an amount of data that needs to be relocated since some of the data would be invalidated in the VSC writes.

In an example, the mode selection system can create a garbage collection road map after receiving a VSC request. In the process, the mode selection system identifies source blocks that are to be taken up during VSC mode and the rest that are taken up post VSC.

In yet another example, the mode selection system additionally leverages the allocated unit (AU) size commitment in the VSC mode by adaptively caching a “next in line” set of control pages until a predetermined VSC end whenever the controller has spare bandwidth or resources such as an available L2P cache and/or available FTL time slot even at a time when only the initial set of L2P page is in use. As such, the mode selection system can adaptively thrash or swap out a set of L2P pages that do not align with a current SGS range and create a cache roadmap. This may also allow the L2P entries in the L2P queue to increase for non-speed class streams and handle them once the AU size is completed.

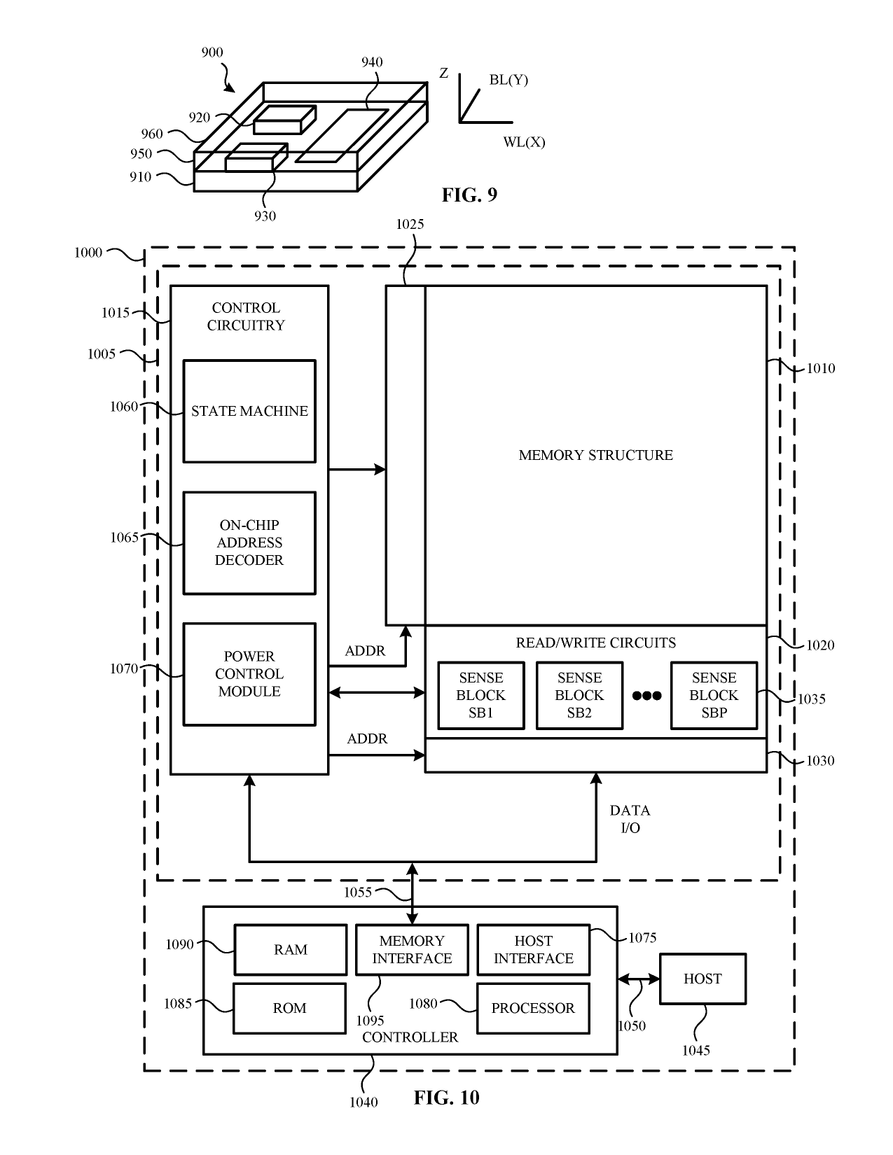

FIG. 9 – FIG. 10 describe example storage devices that may be used with or otherwise implement the various features described herein. For example, the storage devices shown and described with respect to FIG. 9 – FIG. 10 may include various systems and components that are similar to the systems and components shown and described with respect to FIG. 1. For example, the controller 1040 shown and described with respect to FIG. 10 may be similar to the controller 150 of FIG. 1. Likewise, the memory dies 1005 may be similar to the first memory die 165 and/or the second memory die 170 of FIG. 1.

FIG. 9 is a perspective view of a storage device 900 that includes three-dimensional (3D) stacked non-volatile memory according to an example. In this example, the storage device 900 includes a substrate 910. Blocks of memory cells are included on or above the substrate 910. The blocks may include a first block (BLK0 920) and a second block (BLK1 930). Each block may be formed of memory cells (e.g., non-volatile memory elements). The substrate 910 may also include a peripheral area 940 having support circuits that are used by the first block and the second block.

The substrate 910 may also carry circuits under the blocks, along with one or more lower metal layers which are patterned in conductive paths to carry signals from the circuits. The blocks may be formed in an intermediate region 950 of the storage device 900. The storage device may also include an upper region 960. The upper region 960 may include one or more upper metal layers that are patterned in conductive paths to carry signals from the circuits. Each block of memory cells may include a stacked area of memory cells. In an example, alternating levels of the stack represent word lines. While two blocks are depicted, additional blocks may be used and extend in the x-direction and/or the y-direction.

In an example, a length of a plane of the substrate 910 in the x-direction represents a direction in which signal paths for word lines or control gate lines extend (e.g., a word line or drain-end select gate (SGD) line direction) and the width of the plane of the substrate 910 in the y-direction represents a direction in which signal paths for bit lines extend (e.g., a bit line direction). The z-direction represents a height of the storage device 900.

FIG. 10 is a functional block diagram of a storage device 1000 according to an example. The components depicted in FIG. 10 may be electrical circuits. In an example, the storage device 1000 includes one or more memory dies 1005. Each memory die 1005 includes a three-dimensional memory structure 1010 of memory cells (e.g., a 3D array of memory cells), control circuitry 1015, and read/write circuits 1020. In another example, a two-dimensional array of memory cells may be used. The memory structure 1010 is addressable by word lines using a first decoder 1025 (e.g., a row decoder) and by bit lines using a second decoder 1030 (e.g., a column decoder). The read/write circuits 1020 may also include multiple sense blocks 1035 including SB1, SB2, . . ., SBp (e.g., sensing circuitry) which allow pages of the memory cells to be read or programmed in parallel. The sense blocks 1035 may include bit line drivers.

In an example, a controller 1040 is included in the same storage device 1000 as the one or more memory dies 1005. In another example, the controller 1040 is formed on a die that is bonded to a memory die 1005, in which case each memory die 1005 may have its own controller 1040. In yet another example, a controller die controls all of the memory dies 1005.

Commands and data may be transferred between a host 1045 and the controller 1040 using a data bus 1050. Commands and data may also be transferred between the controller 1040 and one or more of the memory dies 1005 by way of lines 1055. In one example, the memory die 1005 includes a set of input and/or output (I/O) pins that connect to lines 1055.

The memory structure 1010 may also include one or more arrays of memory cells. The memory cells may be arranged in a three-dimensional array or a two-dimensional array. The memory structure 1010 may include any type of non-volatile memory that is formed on one or more physical levels of arrays of memory cells having an active area disposed above a silicon substrate. The memory structure 1010 may be in a non-volatile memory device having circuitry associated with the operation of the memory cells, whether the associated circuitry is above or within the substrate.

The control circuitry 1015 works in conjunction with the read/write circuits 1020 to perform memory operations (e.g., erase, program, read, and others) on the memory structure 1010. The control circuitry 1015 may include registers, ROM fuses, and other devices for storing default values such as base voltages and other parameters.

The control circuitry 1015 may also include a state machine 1060, an on-chip address decoder 1065 and a power control module 1070. The state machine 1060 may provide chip-level control of various memory operations. The state machine 1060 may be programmable by software. In another example, the state machine 1060 does not use software and is completely implemented in hardware (e.g., electrical circuits).

The on-chip address decoder 1065 may provide an address interface between addresses used by host 1045 and/or the controller 1040 to a hardware address used by the first decoder 1025 and the second decoder 1030.

The power control module 1070 may control power and voltages that are supplied to the word lines and bit lines during memory operations. The power control module 1070 may include drivers for word line layers in a 3D configuration, select transistors (e.g., SGS and SGD transistors) and source lines. The power control module 1070 may include one or more charge pumps for creating voltages.

The control circuitry 1015, the state machine 1060, the on-chip address decoder 1065, the first decoder 1025, the second decoder 1030, the power control module 1070, the sense blocks 1035, the read/write circuits 1020, and/or the controller 1040 may be considered one or more control circuits and/or a managing circuit that perform some or all of the operations described herein.

In an example, the controller 1040, is an electrical circuit that may be on-chip or off-chip. Additionally, the controller 1040 may include one or more processors 1080, ROM 1085, RAM 1090, memory interface 1095, and host interface 1075, all of which may be interconnected. In an example, the one or more processors 1080 is one example of a control circuit. Other examples can use state machines or other custom circuits designed to perform one or more functions. Devices such as ROM 1085 and RAM 1090 may include code such as a set of instructions. One or more of the processors 1080 may be operable to execute the set of instructions to provide some or all of the functionality described herein.

Alternatively or additionally, one or more of the processors 1080 may access code from a memory device in the memory structure 1010, such as a reserved area of memory cells connected to one or more word lines. The memory interface 1095, in communication with ROM 1085, RAM 1090, and one or more of the processors 1080, may be an electrical circuit that provides an electrical interface between the controller 1040 and the memory die 1005. For example, the memory interface 1095 may change the format or timing of signals, provide a buffer, isolate from surges, latch I/O, and so forth.

The one or more processors 1080 may issue commands to control circuitry 1015, or any other component of memory die 1005, using the memory interface 1095. The host interface 1075, in communication with the ROM 1085, the RAM 1090, and the one or more processors 1080, may be an electrical circuit that provides an electrical interface between the controller 1040 and the host 1045. For example, the host interface 1075 may change the format or timing of signals, provide a buffer, isolate from surges, latch I/O, and so on. Commands and data from the host 1045 are received by the controller 1040 by way of the host interface 1075. Data sent to the host 1045 may be transmitted using the data bus 1050.

Multiple memory elements in the memory structure 1010 may be configured so that they are connected in series or so that each element is individually accessible. By way of a non-limiting example, flash memory devices in a NAND configuration (e.g., NAND flash memory) typically contain memory elements connected in series. A NAND string is an example of a set of series-connected memory cells and select gate transistors.

A NAND flash memory array may also be configured so that the array includes multiple NAND strings. In an example, a NAND string includes multiple memory cells sharing a single bit line and are accessed as a group. Alternatively, memory elements may be configured so that each memory element is individually accessible (e.g., a NOR memory array). The NAND and NOR memory configurations are examples and memory cells may have other configurations.

The memory cells may be arranged in the single memory device level in an ordered array, such as in a plurality of rows and/or columns. However, the memory elements may be arrayed in non-regular or non-orthogonal configurations, or in structures not considered arrays.

In an example, a 3D memory structure may be vertically arranged as a stack of multiple 2D memory device levels. As another non-limiting example, a 3D memory array may be arranged as multiple vertical columns (e.g., columns extending substantially perpendicular to the major surface of the substrate, such as in the y direction) with each column having multiple memory cells. The vertical columns may be arranged in a two-dimensional arrangement of memory cells, with memory cells on multiple vertically stacked memory planes. Other configurations of memory elements in three dimensions can also constitute a 3D memory array.

In another example, in a 3D NAND memory array, the memory elements may be coupled together to form vertical NAND strings that traverse across multiple horizontal memory device levels. Other 3D configurations can be envisioned wherein some NAND strings contain memory elements in a single memory level while other strings contain memory elements which span through multiple memory levels. 3D memory arrays may also be designed in a NOR configuration and in a ReRAM configuration.

One of ordinary skill in the art will recognize that the technology described herein is not limited to a single specific memory structure, but covers many relevant memory structures within the spirit and scope of the technology as described herein and as understood by one of ordinary skill in the art. One of skill in the art also will note that while the invention is described in terms of SLC and QLC memory blocks, in some embodiments, triple-level cell (TLC) memory blocks and multi-level cell (MLC) blocks may be substituted for QLC memory blocks.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

Based on the above, examples of the present disclosure describe a method, comprising: receiving a write command from a host device; determining whether data associated with the write command is a first type of data or a second type of data; based, at least in part, on determining the data associated with the write command is the first type of data, determining whether a logical to physical (L2P) page associated with the data has been pre-loaded into a cache of a data storage device; and based, at least in part, on determining the L2P page associated with the data has been pre-loaded into the cache: updating the L2P page associated with the data; and moving the L2P page from the cache of the data storage device to persistent storage of the data storage device. In an example, the L2P page is pre-loaded into the cache of the data storage device in response to receiving a particular command from the host device. In an example, the particular command is a command to store audiovisual data. In an example, the method also includes determining a logical block address (LBA) range associated with the data. In an example, the method also includes loading the L2P page to the cache of the data storage device based, at least in part, on determining the L2P page associated with the data is absent from the cache of the data storage device. In an example, the L2P page associated with the data is loaded to the cache of the data storage device when a workload of a controller of the data storage device is below a workload threshold. In an example, the method also includes storing L2P entries associated with the data in a L2P queue associated with the data storage device based, at least in part, on determining the data associated with the write command is a second type of data. In an example, updating the L2P page associated with the data comprises updating the L2P page with L2P entries associated with the data. In an example, moving the L2P page from the cache of the data storage device to persistent storage of the data storage device comprises: determining whether the write operation range associated with the L2P page is complete; and moving the L2P page from the cache of the data storage device to the persistent storage of the data storage device based, at least in part, on determining the write operation range associated with the L2P page is complete.

Examples also describe a data storage device, comprising: a controller; and a mode detection system associated with the controller and operable to: receive a first command from a host device; allocate a sequential storage area in the data storage device based, at least in part, on receiving the first command; determine a starting logical block address (LBA) associated with the sequential storage area; pre-load one or more logical to physical (L2P) pages associated with the starting LBA to a cache of a data storage device; receive a second command from the host device; store data associated with the second command in persistent storage of the data storage device; and update the one or more pre-loaded L2P pages in the cache based, at least in part, on storing the data associated with the second command in the persistent memory of the data storage device. In an example, the mode detection system is further operable to determine whether the one or more pre-loaded L2P pages in the cache is associated with the data associated with the second command. In an example, the mode detection system is further operable to move the one or more L2P pages from the cache of the data storage device to the persistent storage of the data storage device. In an example, the mode detection system is further operable to select an operating mode of the data storage device based, at least in part, on another command received from the host device, wherein the another command is received prior to the first command. In an example, the mode detection system is further operable to pre-load additional L2P pages to the cache when a third command is received from the host device.

Still other examples describe a data storage device, comprising: means for receiving a write command from a host device; means for determining a type of data associated with the write command; means for determining whether a logical to physical (L2P) page associated with the data has been pre-loaded into a cache of the data storage device when the means for determining the type of data associated with the write command determines that the data associated with the write command is a particular type of data; means for updating the L2P page in the cache associated with the data while bypassing a L2P queue; and means for moving the L2P page from the cache of the data storage device to persistent storage of the data storage device. In an example, the L2P page is pre-loaded into the cache of the data storage device in response to receiving a particular command from the host device. In an example, the particular command is a command to store audiovisual data. In an example, the data storage device also includes means for determining a logical block address (LBA) range associated with the data. In an example, the data storage device also includes means for loading the L2P page to the cache of the data storage device based, at least in part, on determining the L2P page associated with the data is absent from the cache of the data storage device. In an example, the data storage device also includes means for storing L2P entries associated with the data in a L2P queue associated with the data storage device based, at least in part, on determining the data associated with the write command is another type of data.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Aspects of the present disclosure have been described above with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks. Additionally, it is contemplated that the flowcharts and/or aspects of the flowcharts may be combined and/or performed in any order.

References to an element herein using a designation such as "first," "second," and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A method, comprising:
receiving a write command from a host device;
determining whether data associated with the write command is a first type of data or a second type of data;
based, at least in part, on determining the data associated with the write command is the first type of data, determining whether a logical to physical (L2P) page associated with the data has been pre-loaded into a cache of a data storage device; and
based, at least in part, on determining the L2P page associated with the data has been pre-loaded into the cache:
updating the L2P page associated with the data; and
moving the L2P page from the cache of the data storage device to persistent storage of the data storage device.

2. The method of claim 1, wherein the L2P page is pre-loaded into the cache of the data storage device in response to receiving a particular command from the host device.

3. The method of claim 2, wherein the particular command is a command to store audiovisual data.

4. The method of claim 1, further comprising determining a logical block address (LBA) range associated with the data.

5. The method of claim 1, further comprising loading the L2P page to the cache of the data storage device based, at least in part, on determining the L2P page associated with the data is absent from the cache of the data storage device.

6. The method of claim 5, wherein the L2P page associated with the data is loaded to the cache of the data storage device when a workload of a controller of the data storage device is below a workload threshold.

7. The method of claim 1, further comprising storing L2P entries associated with the data in a L2P queue associated with the data storage device based, at least in part, on determining the data associated with the write command is a second type of data.

8. The method of claim 1, wherein updating the L2P page associated with the data comprises updating the L2P page with L2P entries associated with the data.

9. The method of claim 1, wherein moving the L2P page from the cache of the data storage device to persistent storage of the data storage device comprises:
determining whether the write operation range associated with the L2P page is complete; and
moving the L2P page from the cache of the data storage device to the persistent storage of the data storage device based, at least in part, on determining the write operation range associated with the L2P page is complete.

10. A data storage device, comprising:
a controller; and
a mode detection system associated with the controller and operable to:
receive a first command from a host device;
allocate a sequential storage area in the data storage device based, at least in part, on receiving the first command;
determine a starting logical block address (LBA) associated with the sequential storage area;
pre-load one or more logical to physical (L2P) pages associated with the starting LBA to a cache of a data storage device;
receive a second command from the host device;
store data associated with the second command in persistent storage of the data storage device; and
update the one or more pre-loaded L2P pages in the cache based, at least in part, on storing the data associated with the second command in the persistent memory of the data storage device.

11. The data storage device of claim 10, wherein the mode detection system is further operable to determine whether the one or more pre-loaded L2P pages in the cache is associated with the data associated with the second command.

12. The data storage device of claim 10, wherein the mode detection system is further operable to move the one or more L2P pages from the cache of the data storage device to the persistent storage of the data storage device.

13. The data storage device of claim 10, wherein the mode detection system is further operable to select an operating mode of the data storage device based, at least in part, on another command received from the host device, wherein the another command is received prior to the first command.

14. The data storage device of claim 10, wherein the mode detection system is further operable to pre-load additional L2P pages to the cache when a third command is received from the host device.

15. A data storage device, comprising:
means for receiving a write command from a host device;
means for determining a type of data associated with the write command;
means for determining whether a logical to physical (L2P) page associated with the data has been pre-loaded into a cache of the data storage device when the means for determining the type of data associated with the write command determines that the data associated with the write command is a particular type of data;
means for updating the L2P page in the cache associated with the data while bypassing a L2P queue; and
means for moving the L2P page from the cache of the data storage device to persistent storage of the data storage device.

16. The data storage device of claim 15, wherein the L2P page is pre-loaded into the cache of the data storage device in response to receiving a particular command from the host device.

17. The data storage device of claim 16, wherein the particular command is a command to store audiovisual data.

18. The data storage device of claim 15, further comprising means for determining a logical block address (LBA) range associated with the data.

19. The data storage device of claim 15, further comprising means for loading the L2P page to the cache of the data storage device based, at least in part, on determining the L2P page associated with the data is absent from the cache of the data storage device.

20. The data storage device of claim 15, further comprising means for storing L2P entries associated with the data in a L2P queue associated with the data storage device based, at least in part, on determining the data associated with the write command is another type of data.
